(19) United States
(12) Patent Application Publication
(10) Pub. No.: US 2008/0040564 A1
(43) Pub. Date: Feb. 14, 2008

(54) Sychronized Light Path Scheme Across Mutiple SAS Storage Enclosures

(75) Inventors: Robert A. Kubo, Tucson, AZ (US); Gregg S. Lucas, Tucson, AZ (US); Tohru Sumiyoshi, Tokyo (JP); Yoshihiko Terashita, Kanagawa-ken (JP)

Correspondence Address: QUARLES & BRADY LLP, 1 SOUTH CHURCH AVENUE, SUITE 1700, TUCSON, AZ, 85701, US

(73) Assignee: INTERNATIONAL BUSINESS MACHINES CORPORATION, Armonk, NY (US)

(21) Appl. No.: 11/463,833

(22) Filed: Aug. 10, 2006

(51) Int. Cl. G06F 13/00

(52) U.S. Cl. 711/154

(57) ABSTRACT

A system for synchronizing identify indicators in a computer storage subsystem includes a switch module electrically coupled to an initiator module. The switch module implements a queuing scheme, receives an identify command from the initiator module, executes the queuing scheme to synchronize the identify command, and broadcasts the identify command to a target device in the computer storage subsystem. A system for synchronizing identify indicators in a computer storage subsystem includes a switch module electrically coupled to a initiator module. The switch module receives an identify command issued by the initiator module, and invokes a distribution algorithm to serially distribute the identify command to a downstream target device in the computer storage subsystem. A method for synchronizing identify indicators in a computer storage subsystem is also disclosed.

### BACKGROUND OF THE INVENTION

1. Field of the Invention

The present invention relates in general to computers, and, more particularly, to an apparatus and method to implement a synchronized light path scheme across multiple Serial-Attached-SCSI (SAS) storage enclosures.

2. Description of the Prior Art

In storage subsystems of computer systems, status indicators can be provided across an entire domain to identify which storage enclosures and related field-replaceable units (FRUs) or customer-replaceable units (CRUs) constitute the domain. The status indicator system is part of a larger, higher-level architecture referred to as “light path” and involves utilizing Identify indicators on each FRU/CRU. These Identify indicators, when activated, blink at a rate of approximately ½ cycles per second (Hz). Other similar rates are possible.

In Fibre-Channel Arbitrated Loop (FC-AL) based storage subsystems, the light path function is achieved by the RAID Controller serially issuing Identify commands to all of its downstream storage enclosures in the FC-AL loop. Such commands are transmitted in-band over the FC-AL network. In FC-AL, there is no broadcast capability; i.e., the commands are serially sequenced to each of the enclosures in the domain. When invoked, the Identify function results in a number of randomly blinking status indicators.

Thus, there is a need for a light path implementation across multiple SAS storage enclosures where all of the Identify indicators synchronously blink. In the alternative, there is a need at a minimum for all the Identify indicators within a meaningfully close proximity to synchronously blink. The light path implementation should take advantage of existing hardware and firmware in the computer system to reduce cost and complexity of the implementation.

### SUMMARY OF THE INVENTION

In one embodiment, the present invention is a system for synchronizing identify indicators in a computer storage subsystem, comprising a switch module electrically coupled to an initiator module, wherein the switch module implements a queuing scheme, receives an identify command from the initiator module, executes the queuing scheme to synchronize the identify command, and broadcasts the identify command to a target device in the computer storage subsystem.

In another embodiment, the present invention is a system for synchronizing identify indicators in a computer storage subsystem, comprising a switch module electrically coupled to an initiator module, wherein the switch module receives an identify command, the identify command issued by the initiator module, and invokes a distribution algorithm to serially distribute the identify command to a downstream target device in the computer storage subsystem.

In another embodiment, the present invention is a method for synchronizing identify indicators by a switch module in a computer storage subsystem, comprising implementing a queuing scheme, receiving an identify command from an initiator module, executing a queuing scheme to synchronize the identify command, and broadcasting the identify command to a target device in the subsystem.

In still another embodiment, the present invention is a method for synchronizing identify indicators by a switch module in a computer storage subsystem, comprising receiving an identify command, the identify command issued by an initiator module, and invoking a distribution algorithm to serially distribute the identify command to a downstream target device in the subsystem.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an example of a storage subsystem of a computer system;

FIG. 2 illustrates a network of interconnected storage components, including RAID controller blades, SAS switches and expanders, and drive enclosure blades (DEBs);

FIG. 3 illustrates a flow-chart diagram of a first example implementation method of synchronized light path Identify indicators in a computer subsystem; and

FIG. 4 illustrates a flow-chart diagram of a second example implementation method of synchronized light path Identify indicators in a computer subsystem.

### DETAILED DESCRIPTION OF THE DRAWINGS

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, punch card, flash memory, integrated circuits, or other digital processing apparatus memory device.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

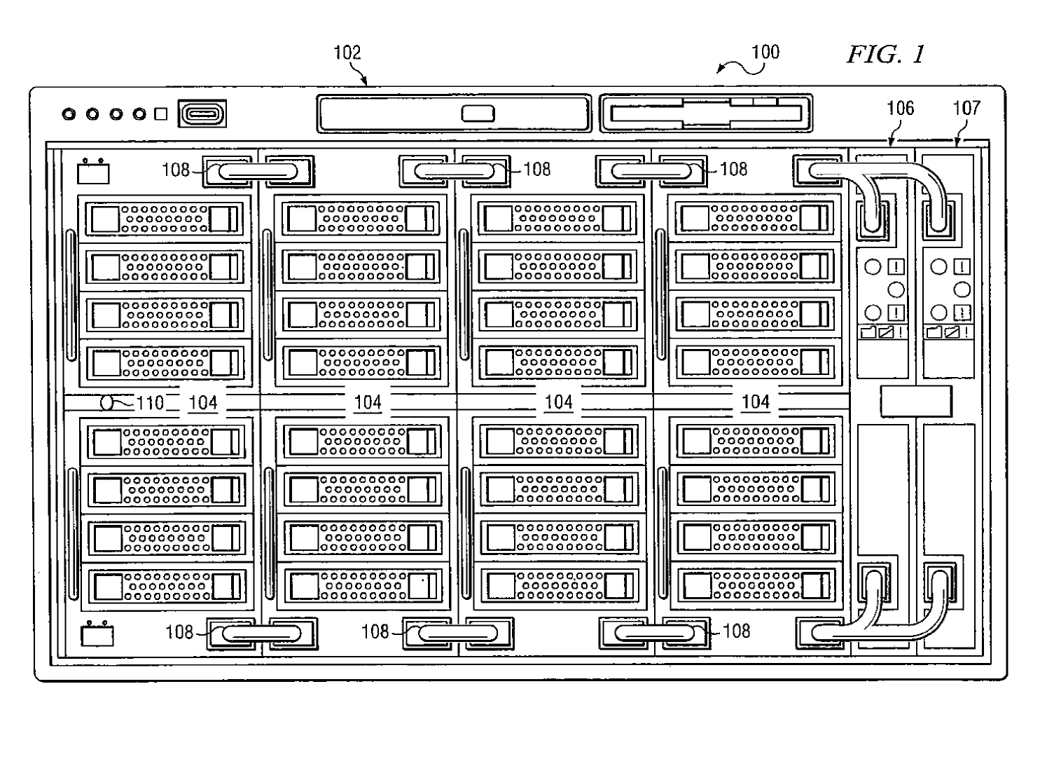

Turning to FIG. 1, an example storage subsystem 100 as part of an overall computer system is shown. Subsystem 100 consists of a rack-mount enclosure 102 having fourteen blade slots for various blade-type devices. In the implementation shown, four drive enclosure blades 104 (DEBs) are shown from left to right. Each DEB 104 is three standard blades wide. As a result, four DEBs 104 take up twelve standard blade server blade slots in subsystem 100. Each DEB 104 contains a plurality of hard disk drives (HDDs) integrated into a series of interface cards. In the implementation shown, DEB 104 contains 24 HDDS, with three HDDs integrated per interface card. In addition to having four DEB 104 devices, two RAID controller blades 106 (RCBs) are shown, the first adjacent to the second, in the far right-hand space of subsystem 100.

In various mass storage embodiments such as DEBs and their associated HDDs, the mass storage components can include the appropriate functionality to communicate over various device located layers such as an application layer, a transport layer, a link layer, and/or a physical layer, in accordance with various industry specifications. For example, DEBs 104 can provide the functionality to communicate via layers in accordance with a Serial-ATA industry standard interface specification, such as the Serial-ATA I interface specification (SATA) promulgated by the Serial ATA Working Group, the Serial ATA II interface specification promulgated by the Serial ATA II Work Group, or the SAS specification promulgated by the Serial Attached SCSI Working Group, or any progeny of these specifications. As illustrated, subsystem 100 includes a series of external cables 10 which are daisy-chained between each respective DEB 104 and RCB 106. Cables 108 are attached to various interface cards (controllers) which are mounted at the top and bottom of each DEB 104. In addition, cables 108 are connected to interface devices which link DEBs 104 with RCBs 106. Finally, light path (Identify) indicators 110 are seen integrated into each DEB 104.

Enclosure 102 can integrate up to four (4) DEBs 104 as previously described. From a Human Factors and Industrial Design perspective, it is desirable for the Identify indicators 110 of all the DEBs 104 to be synchronized. Subsystem 100 can initiate an Identify process using one of two entities, which results in non-synchronized Identify status indicators. First, the RCB 106 can issue an In-band Identify command to all the DEBs 104. Secondly, a Management Module (MM) can issue an Identify command to all related storage blades via an RS485 interface. It is desirable to synchronize the Identify indicators 110 across all integrated DEBs 104. Having synchronized indicators 110 becomes increasingly important in blade-type storage subsystems 100 where DEBs 104 are visually tightly coupled.

Synchronization of indicators 110 becomes increasingly important as multiple independent storage subsystems (SAS domain) come to coexist in a rack-mount setting within the same rack and even within the same chassis within the same rack. At the most granular level, each DEB 104 can be its own subsystem, in which case the indicators 110 would only blink in that specific DEB 104. As such, synchronization of indicators 110 becomes important to identify specific subsystems in a larger overall domain.

In a SAS/SATA storage subsystem 100 that implements light path, either of two methods can be employed to synchronize the light path Identify indicators 110 across the entire SAS domain. Each of these methods makes use of “primitives”. Primitives are dwords, units of data 32 bits long on a 32-bit x86 platform. The use of primitives, and the primitive format, is defined in section 7.2 of the SAS specification document “Working Draft Serial Attached SCSI-1.1 (SAS-1.1)”, revision 9e, 24 Jul. 2005 and published by T10, a technical subcommittee of the International Committee for Information Technology Standards (INCITS) which is incorporated herein by reference.

The first of the two synchronization methods involves a broadcast method utilized to synchronize the blinking of the Identify indicators 110 across the SAS/SATA domain network (e.g., multiple DEBs 104). The broadcast method must provide for low latency broadcast primitive commands such that all DEBs 104 receive the “Identify” command at approximately the same time. The second of the two methods involves utilizing a vendor-unique SAS Notify primitive which is defined to allow timely synchronization of light path indicators 110. An SAS switch sequences Notify primitives to each DEB 104 in the domain.

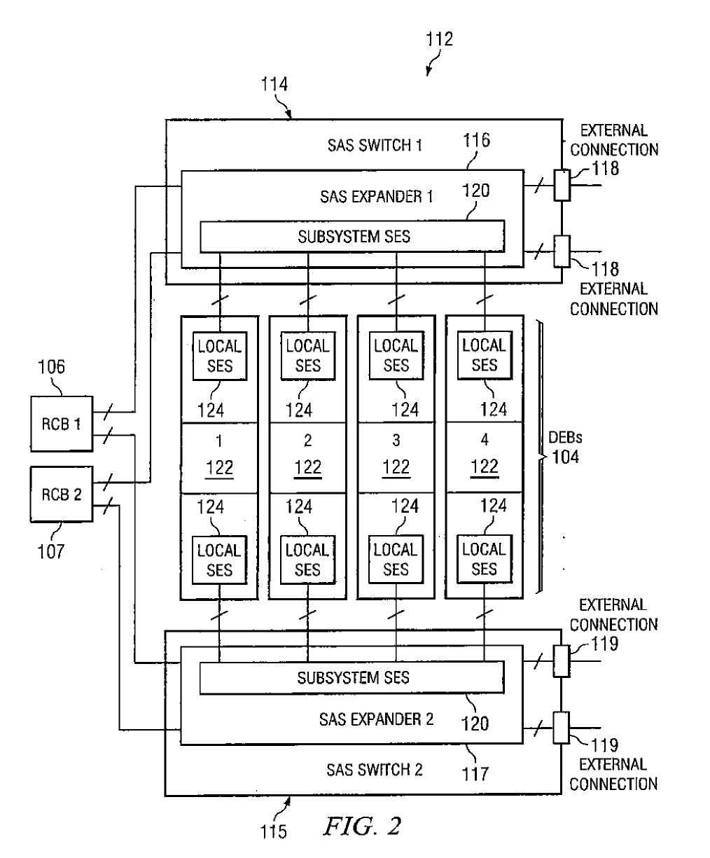

Turning to FIG. 2, an example RCB/SAS Switch/DEB implementation 112 is shown. RCBs 106, 107 are connected to SAS switches 114, 115 through a typical signal bearing medium. SAS switch modules 114, 115 include SAS expander modules 116, 117. SAS expanders 116, 117 are generally industry-defined devices which function as cross-point switches. Use of the term “SAS switch module” is contemplated to refer to a higher-level, generic nomenclature which includes various switches and expanders as are industry standard. Inclusive to SAS expanders 116, 117 are SCSI Enclosure Services (SES) modules 120. The use of SCSI Enclosure Services (SES) is commonplace in storage products as a conventional way to provide communication. SES is an industry-defined standard that functions to monitor and understand the environment of a storage device enclosure. In the case of the DEB/RAID controller implementation as previously described, SES functions to monitor and understand the environment of the DES 104. SES can report temperature and voltage excursions associated with the DEB 104. SES provides for powering on or off the hard disk drives (HDDs) 122 integrated into each DEB 104. Four DEBs 104 are shown linked to switches 106, 107 through SES modules 124 local to each DEB 104, and then through expander modules 116, 117. External connections 118, 119 connect the SAS switch modules 114, 115 (including expander modules 116, 117) to external components of the storage subsystem.

Again, a first implementation to allow timely synchronization of light path Identify indicators 110 utilizes a broadcast primitive command. In general, broadcasts are used to notify all SAS ports in a domain of a particular event. For example, under the T10 SAS standard previously described, the Broadcast (Change) command is utilized to provide notification of a configuration change to all SAS ports in a domain. A new SAS Broadcast (Identify) primitive command can be defined which indicates to SAS target device(s) that the device(s) should turn on (statically or blinking) their LightPath Identify indicator 110. To invoke the light path Identify function, a SAS/SATA initiator (e.g., RCB 106, 107) broadcasts the Identify command to all attached downstream DEBs 104.

Even though the Identify command is broadcast, there may be a small time lag amongst all the resultant downstream primitive commands. To clarify, the first component in the path of the command is typically an SAS switch module 114, 115 which can implement a queuing scheme for all downstream command/data transmission, be it payload transmission or unique commands such as broadcast primitives. Each SAS expander module 116, 117 supports such a queue and allows intermix of data and commands. Even if an incoming command (e.g., Identify command from the initiator) is received, it may have to “wait in line” until other in-progress traffic is finished. This traffic intermix varies from SAS port to SAS port.

Even though an SAS switch module 114, 115 broadcasts an Identify command to multiple downstream targets, the commands may arrive at different times. To better synchronize a broadcast command, a high priority queue can be implemented in each SAS expander module 116, 117 such that specialized broadcast commands can be quickly transmitted once they are received. In general, broadcast commands are non-time critical. In the case of a light path implementation, there is some desire for all the indicators to blink in apparent unison. Consequently, it is important to implement a high-speed queue in the SAS switch module 114, 115. Such a high-speed queue would prioritize the Identify command ahead of lower priority commands. Alternatively, a synchronizing queue can be implemented which waits until all the ports are available and then issues the broadcast command.

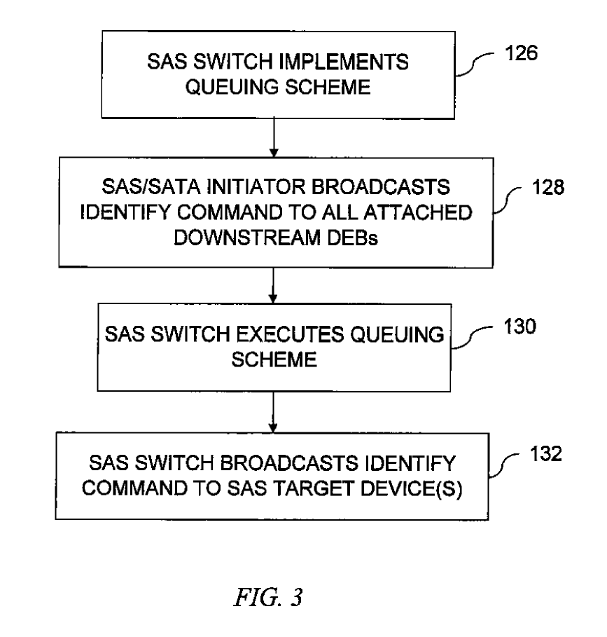

Turning to FIG. 3, an example method of implementing a SAS Broadcast (Identify) command is depicted. As described previously, a high-speed queue is first implemented (step 126) in the SAS switch module 114, 115. Alternatively, a synchronizing queue is implemented (step 126). Either implementation can be accomplished using firmware operating in conjunction with SAS expander modules 116, 117. The SAS/SATA initiator (again, RCB 106, 107) broadcasts a predefined Identify command to those downstream DEBs 104 (step 128) which are included in the corresponding SAS domain. One SAS expander module 116, 117 can support multiple independent SAS domains. As a result, module 116, 117 can selectively broadcast the Identify command to those DEBs 104 in the domain which are being identified. The SAS switch module 114, 115 executes the predefined queuing scheme (step 130) to, for example, wait until all relevant SAS ports are available to issue the broadcast command. The SAS switch module 114, 115 then broadcasts the Identify command to the downstream SAS target device(s) (step 132).

A second implementation to allow timely synchronization of light path Identify indicators 110 utilizes a notify primitive command. Several notify primitives are also defined in the SAS T10 specification previously described, including Notify (Enable Spinup), which specifies to an SAS target device that the device may temporarily consume additional power while transitioning into the active or idle power condition state. In general, notify primitives cannot be broadcast. A new, vendor-unique Notify (Identify) primitive can be defined specifically for invoking a light path function. Because notify primitives are not broadcast, once notify primitives are issued, they are not required to wait for queued-up traffic to quiesce.

A Notify frame can be inserted in the data stream as an “Align” character, consistent with SAS standards. To invoke the light path Identify function using a Notify (Identify) primitive command, a SAS/SATA initiator (again, e.g., RCB 106, 107) issues the vendor-unique Notify (Identify) command to its downstream SAS switch module 114, 115. The SAS switch module 114, 115 receives the command, and, being a central point in the SAS topology, invokes an algorithm which serially distributes the Identify command to all downstream target devices in a high-priority fashion.

Even though the Notify (Identify) function operates in a serial manner, the process happens sufficiently fast to effectuate a synchronized light path indication scheme. More recently, newly defined notify primities such as Notify (Early Power Off Warning) have emerged from the SAS T10 standards committee. The Early Power Off Warning (EPOW) primitive is coupled with the power supply system and is unrelated to any light path functions.

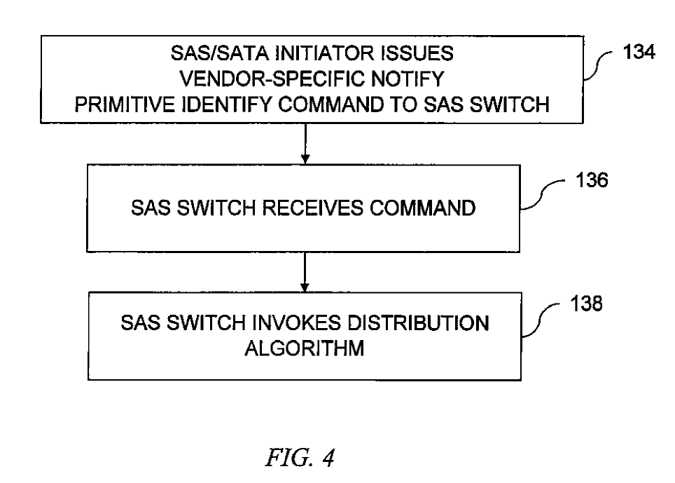

Turning to FIG. 4, an example implementation of synchronized light path Identify indicators 110 is depicted using a vendor-unique Notify (Identify) primitive scheme. Again, as previously described, an SAS/SATA intiator issues the notify primitive command to a downstream SAS switch (step 134). The SAS switch receives the command (step 136). Finally, the SAS switch invokes a predefined distribution algorithm which serially distributes the Identify command to all downstream target devices (step 138).

Utilizing either an implementation of a broadcast primitive or notify primitive command, synchronization of light path Identify indicators 110 can be seen using existing infrastructure (hardware and software) in a cost-effective and efficient manner.

While one or more embodiments of the present invention have been illustrated in detail, the skilled artisan will appreciate that modifications and adaptations to those embodiments may be made without departing from the scope of the present invention as set forth in the following claims.

What is claimed is:

1. A system for synchronizing identify indicators in a computer storage subsystem, comprising:
a switch module electrically coupled to an initiator module, wherein the switch module
implements a queuing scheme,
receives an identify command from the initiator module,
executes the queuing scheme to synchronize the identify command, and
broadcasts the identify command to a target device in the computer storage subsystem.

2. The system of claim 1, wherein the switch module is compliant with a Serial Attached SCSI (SAS) specification.

3. The system of claim 1, wherein the switch module is compliant with a Serial Advanced Technology Attachment (SATA) specification.

4. The system of claim 1, wherein the identify command comprises a broadcast identify primitive command compliant with a Serial Attached SCSI (SAS) specification.

5. The system of claim 1, wherein the switch module is implemented as a logic control entity operating alternatively as software, hardware or a combination of software and hardware on the computer storage subsystem.

6. A system for synchronizing identify indicators in a computer storage subsystem, comprising:
a switch module electrically coupled to an initiator module, wherein the switch module
receives an identify command issued by the initiator module, and
invokes a distribution algorithm to serially distribute the identify command to a downstream target device in the computer storage subsystem.

7. The system of claim 6, wherein the switch module is compliant with a Serial Attached SCSI (SAS) specification.

8. The system of claim 6, wherein the switch module is compliant with a Serial Advanced Technology Attachment (SATA) specification.

9. The system of claim 6, wherein the identify command comprises a notify primitive command compliant with a Serial Attached SCSI (SAS) specification.

10. The system of claim 6, wherein the switch module is implemented as a logic control entity operating alternatively as software, hardware or a combination of software and hardware on the computer storage subsystem.

11. A method for synchronizing identify indicators by a switch module in a computer storage subsystem, comprising:
implementing a queuing scheme;
receiving an identify command from an initiator module;
executing a queuing scheme to synchronize the identify command; and
broadcasting the identify command to a target device in the subsystem.

12. The method of claim 11, wherein the identify command further comprises a broadcast identify primitive command compliant with a Serial Attached SCSI (SAS) specification.

13. The method of claim 11, wherein the switch module is compliant with a Serial Advanced Technology Attachment (SATA) specification.

14. The method of claim 11, wherein the switch module is compliant with a Serial Attached SCSI (SAS) specification.

15. The method of claim 11, wherein the switch module is implemented as a logic control entity operating alternatively as software, hardware or a combination of software and hardware on the subsystem.

16. A method for synchronizing identify indicators by a switch module in a computer storage subsystem, comprising:
receiving an identify command issued by an initiator module, and
invoking a distribution algorithm to serially distribute the identify command to a downstream target device in the subsystem.

17. The method of claim 16, wherein the switch module is compliant with a Serial Attached SCSI (SAS) specification.

18. The method of claim 16, wherein the switch module is compliant with a Serial Advanced Technology Attachment (SATA) specification.

19. The method of claim 16, wherein the identify command her comprises a notify primitive command compliant with a Serial Attached SCSI (SAS) specification on to the storage device.

20. The method of claim 16, wherein the switch module is implemented as a logic control entity operating alternatively as software, hardware or a combination of software and hardware on the subsystem.
